(19) United States
(12) Patent Application Publication
(10) Pub. No.: US 2012/0196026 A1
(43) Pub. Date: Aug. 2, 2012

(54) STABILIZATION OF CITRUS FRUIT BEVERAGES

(76) Inventors: Sarah Medina, Winnipeg (CA); Martin Schweizer, Winnipeg (CA)

(21) Appl. No.: 13/444,316

(22) Filed: Apr. 11, 2012

Related U.S. Application Data
(63) Continuation of application No. 12/984,130, filed on Jan. 4, 2011.

(51) Int. Cl. A23L 2/02; A23L 2/66; A23J 1/14

(52) U.S. Cl. 426/598; 426/656

(57) ABSTRACT

A composition which permits protein fortification of citrus juices, particularly orange juice, or beverages containing citrus juices, to be carried out without separation of the juice or beverage and the rapid development of a clear or nearly clear liquid layer on top of the juice or beverage, comprises a soy protein product having a protein content of at least about 60 wt % (N×6.25), preferably at least about 90 wt %, and preferably at least about 100 wt %, which is completely soluble in water at an acid pH value of less than about 4.4 and which is heat stable in aqueous solution, and at least one of at least one calcium salt and at least one organic acid.

### FIELD OF INVENTION

This invention relates to stabilization of protein fortified citrus fruit beverages.

### BACKGROUND TO THE INVENTION

In U.S. patent application Ser. No. 12/603,087 filed Oct. 21, 2009 (US Patent Publication No. 2010-0098818, WO 2010/045727) (S701), assigned to the assignee hereof and the disclosures of which are incorporated herein by reference, there is described the production of a novel soy protein isolate that produces transparent and heat stable solutions at low pH values and, therefore, which may be used for protein fortification of, in particular, soil drinks and sports drinks, as well as other aqueous systems, without precipitation of protein.

The soy protein isolate provided therein has a unique combination of parameters not found in other soy isolates. The product is completely soluble at acid pH values of less than about 4.4 and solutions thereof are heat stable, permitting thermal processing, such as hot fill applications. No stabilizers or other additives are necessary to maintain the protein in solution or suspension. The soy protein solution has no “beany” flavour and no off odours. The product is low in phytic acid and no enzymes are required in the production of the soy protein isolate. The soy protein isolate is also highly soluble at about pH 7.

The novel soy protein isolate having a protein content of at least about 90 wt % (N×6.25) preferably at least about 100 wt %, on a dry weight basis (d.b.) is produced by a method which comprises:

(a) extracting a soy protein source with an aqueous calcium salt solution, particularly calcium chloride solution, to cause solubilization of soy protein from the protein source and to form an aqueous soy protein solution,

(b) separating the aqueous soy protein solution from residual soy protein source,

(c) optionally diluting the aqueous soy protein solution,

(d) adjusting the pH of the aqueous soy protein solution to a pH of about 1.5 to about 4.4, preferably about 2 to about 4, to produce an acidified clear soy protein solution,

(e) optionally heat treating the acidified solution to reduce the activity of anti-nutritional trypsin inhibitors and the microbial load,

(f) optionally concentrating the aqueous clear soy protein solution while maintaining the ionic strength substantially constant by using a selective membrane technique,

(g) optionally diafiltering the concentrated soy protein solution,

(h) optionally pasteurizing the concentrated soy protein solution to reduce the microbial load, and

(i) optionally drying the concentrated soy protein solution.

In attempting to use the novel soy protein isolate for protein fortification of a variety of commercial orange juice products, separation of components of the orange juice was observed along with the rapid development of a clear or nearly clear (slightly hazy) upper liquid layer in the juice sample.

### SUMMARY OF INVENTION

It has now been found that the novel soy protein isolate may be used to provide protein fortified citrus fruit juices without the rapid development of a clear or nearly clear upper liquid layer in the juice by utilizing calcium salts alone, organic acids alone or the two species in combination.

Accordingly, in one aspect of the present invention, there is provided a composition comprising:

a soy protein product having a protein content of at least about 60 wt (N×6.25) which is completely soluble in water at an acid pH value of less than about 4.4 and which is heat stable in aqueous solution, and at least one of

at least one calcium salt and

at least one organic acid,

said composition being soluble in citrus fruit juices or beverages containing citrus fruit without separation of components of the citrus fruit juice or beverage and the rapid development of a substantially clear upper liquid layer in the juice or beverage.

As can be seen from the Examples below, there are many possible formulations for the use of calcium salts and organic acids in the stabilization of orange juice and other citrus fruit juices or other blended beverages containing such juices, fortified by the novel soy protein isolate. Higher calcium levels are required to achieve stability when little or no organic acid is employed, while lower calcium values may be used where higher organic acid values are employed.

In another aspect of the present invention, there is provided a protein-fortified citrus fruit juice or beverage containing citrus fruit juice having dissolved therein the composition of the invention. The protein-fortified citrus fruit juice or beverage containing citrus fruit juice preferably has the composition:

about 0.1 to about 10% w/w of soy protein from soy protein product, and at least one of

about 0 to about 1.7% w/w of at least one calcium salt, and

about 0 to about 1% w/w of at least one organic acid.

Suitable calcium salts include, but are not limited to, calcium chloride, calcium lactate and calcium lactate gluconate. Suitable organic acids include, but are not limited to, malic acid and citric acid. Combinations of calcium salts and/or organic acids which have been found satisfactory in stabilizing orange juice against separation and the development of a substantially clear upper liquid layer when fortified with approximately 1.9% w/w of the novel soy protein isolate include:
1.04% w/w calcium lactate alone
0.08% w/w calcium lactate with 0.95% w/w malic acid
0.08% w/w calcium lactate with 0.95% w/w citric acid
0.75% w/w calcium lactate with 0.94% w/w malic acid
0.76% w/w calcium lactate with 0.47% w/w malic acid
0.38% w/w calcium chloride alone
0.04 and 0.19% w/w calcium chloride and 0.95% w/w malic acid
0.19% w/w calcium chloride with 0.48% w/w malic acid
0.95 and 1.23% w/w calcium lactate gluconate alone
0.09 and 0.47% w/w calcium lactate gluconate and 0.95% w/w malic acid
0.48% w/w calcium lactate gluconate and 0.48% w/w malic acid
0.95% w/w malic acid alone

Clearly other combinations of calcium salts and/or organic acids will function in as equivalent manner.

While the present invention refers mainly to the use of soy protein isolates, it is contemplated that soy protein products of lesser purity may be used having similar properties to the soy protein isolate. Such lesser purity products may have a protein concentration of at least about 60 wt % (N×6.25) d.b.

### GENERAL DESCRIPTION OF INVENTION

The initial step of the process of providing the soy protein product utilized in the composition described herein involves solubilizing soy protein from a soy protein source. The soy protein source may be soybeans or any soy product or by-product derived from the processing of soybeans, including but not limited to soy meal, soy flakes, soy grits and soy flour. The soy protein source may be used in the full fat form, partially defatted form or fully defatted form. Where the soy protein source contains an appreciable amount of fat, an oil-removal step generally is required during the process. The soy protein recovered from the soy protein source may be the protein naturally occurring in soybean or the proteinaceous material may be a protein modified by genetic manipulation but possessing characteristic hydrophobic and polar properties of the natural protein.

Protein solubilization from the soy protein source material is effected most conveniently using calcium chloride solution, although solutions of other calcium salts, may be used. In addition, other alkaline earth metal compounds may be used, such as magnesium salts. Further, extraction of the soy protein from the soy protein source may be effected using calcium salt solution in combination with another salt solution, such as sodium chloride. Additionally, extraction of the soy protein from the soy protein source may be effected using water or other salt solution, such as sodium chloride, with calcium salt subsequently being added to the aqueous soy protein solution produced in the extraction step. Precipitate formed upon addition of the calcium salt is removed prior to subsequent processing.

As the concentration of the calcium salt solution increases, the degree of solubilization of protein from the soy protein source initially increases until a maximum value is achieved. Any subsequent increase in salt concentration does not increase the total protein solubilized. The concentration of calcium salt solution which causes maximum protein solubilization varies depending on the salt concerned. It is usually preferred to utilize a concentration value less than about 1.0 M, and more preferably a value of about 0.10 to about 0.15 M.

In a batch process, the salt solubilization of the protein is effected at a temperature of from about 1° C. to about 100° C., preferably about 15° C. to about 60° C., more preferably about 15° to about 35° C., preferably accompanied by agitation to decrease the solubilization time, which is usually about 1 to about 60 minutes. It is preferred to effect the solubilization to extract substantially as much protein from the soy protein source as is practicable, so as to provide an overall high product yield.

In a continuous process, the extraction of the soy protein from the soy protein source is carried out in any manner consistent with effecting a continuous extraction of soy protein from the soy protein source. In one embodiment, the soy protein source is continuously mixed with the calcium salt solution and the mixture is conveyed through a pipe or conduit having a length and at a flow rate for a residence time sufficient to effect the desired extraction in accordance with the parameters described herein. In such a continuous procedure, the salt solubilization step is effected rapidly, in a time of up to about 10 minutes, preferably to effect solubilization to extract substantially as much protein from the soy protein source as is practicable. The solubilization in the continuous procedure is effected at temperatures between about 1° C. and about 100° C., preferably about 15° C. to about 60° C., more preferably between about 15° C. and about 35° C.

The extraction is generally conducted at a pH of about 5 to about 11, preferably about 5 to about 7. The pH of the extraction system (soy protein source and calcium salt solution) may be adjusted to any desired value within the range of about 5 to about 11 for use in the extraction step by the use of any convenient food grade acid, usually hydrochloric acid or phosphoric acid, or food grade alkali, usually sodium hydroxide, as required.

The concentration of soy protein source in the calcium salt solution during the solubilization step may vary widely. Typical concentration values are about 5 to about 15% w/v.

The protein extraction step with the aqueous salt solution has the additional effect of solubilizing fats which may be present in the soy protein source, which then results in the fats being present in the aqueous phase.

The protein solution resulting from the extraction step generally has a protein concentration of about 5 to about 50 g/L, preferably about 10 to about 50 g/L.

The aqueous calcium salt solution may contain an antioxidant. The antioxidant may be any convenient antioxidant, such as sodium sulfite or ascorbic acid. The quantity of antioxidant employed may vary from about 0.01 to about 1 wt % of the solution, preferably about 0.05 wt %. The antioxidant serves to inhibit oxidation of any phenolics in the protein solution.

The aqueous phase resulting from the extraction step then may be separated from the residual soy protein source, in any convenient manner, such as by employing a decanter centrifuge or any suitable sieve, followed by disc centrifugation and/or filtration, to remove residual soy protein source material. The separated residual soy protein source may be dried for disposal. Alternatively, the separated residual soy protein source may be processed to recover some residual protein. The separated residual soy protein source may be re-extracted with fresh calcium salt solution and the protein solution yielded upon clarification combined with the initial protein solution for further processing as described below. Alternatively, the separated residual soy protein source may be processed by a conventional isoelectric precipitation procedure or any other convenient procedure to recover such residual protein.

Where the soy protein source contains significant quantities of fat, as described in U.S. Pat. Nos. 5,844,086 and 6,005,076, assigned to the assignee hereof and the disclosures of which are incorporated herein by reference, then the defatting steps described therein may be effected on the separated aqueous protein solution. Alternatively, defatting of the separated aqueous protein solution may be achieved by any other convenient procedure.

The aqueous soy protein solution may be treated with an adsorbent, such as powdered activated carbon or granulated activated carbon, to remove colour and/or odour compounds. Such adsorbent treatment may be carried out under any convenient conditions, generally at the ambient temperature of the separated aqueous protein solution. For powdered activated carbon, an amount of about 0.025% to about 5% w/v, preferably about 0.05% to about 2% w/v, is employed. The adsorbing agent may be removed from the soy solution by any convenient means, such as by filtration.

The resulting aqueous soy protein solution may be diluted generally with about 0.5 to about 10 volumes, preferably about 0.5 to about 2 volumes of aqueous diluent, in order to decrease the conductivity of the aqueous soy protein solution to a value of generally below about 90 mS, preferably about 4 to about 18 mS. Such dilution is usually effected using water, although dilute salt solution, such as sodium chloride or calcium chloride having a conductivity of up to about 3 mS, may be used.

The diluent with which the soy protein solution is mixed may have a temperature of about 2° to about 70° C., preferably about 10° to about 50° C., more preferably about 20° to about 30° C.

The diluted soy protein solution then is adjusted in pH to a value of about 1.5 to about 4.4, preferably about 2 to about 4, by the addition of any suitable food grade acid to result in a clear acidified aqueous soy protein solution. The clear acidified aqueous soy protein solution has a conductivity of generally below about 95 mS, preferably about 4 to about 23 mS.

The clear acidified aqueous soy protein solution may be subjected to a heat treatment to inactivate heat labile anti-nutritional factors, such as trypsin inhibitors, present in such solution as a result of extraction from the soy protein source material during the extraction step. Such a heating step also provides the additional benefit of reducing the microbial load. Generally, the protein solution is heated to a temperature of about 70° to about 160° C. for about 10 seconds to about 60 minutes, preferably about 80° to about 120° C. for about 10 seconds to about 5 minutes, more preferably about 85° to about 95° C. for about 30 seconds to about 5 minutes. The heat treated acidified soy protein solution then may be cooled for further processing as described below, to a temperature of about to about 60° C., preferably about 20° C. to about 35° C.

The optionally diluted, acidified and optionally heat treated protein solution may optionally be polished by any convenient means, such as by filtering, to remove any residual particulates.

The resulting clear acidified aqueous soy protein solution may be directly dried to produce a soy protein product. In order to provide a soy protein product having a decreased impurities content and a reduced salt content, such as a soy protein isolate, the clear acidified aqueous soy protein solution may be processed prior to drying.

The clear acidified aqueous soy protein solution may be concentrated to increase the protein concentration thereof while maintaining the ionic strength thereof substantially constant. Such concentration generally is effected to provide a concentrated soy protein solution having a protein concentration of about 50 to about 300 g/L, preferably about 100 to about 200 g/L.

The concentration step may be effected in any convenient manner consistent with hatch or continuous operation, such as by employing any convenient selective membrane technique, such as ultrafiltration or diafiltration, using membranes, such as hollow-fibre membranes or spiral-wound membranes, with a suitable molecular weight cut-off, such as about 3,000 to about 1,000,000 Daltons, preferably about 5,000 to about 100,000 Daltons, having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass therethrough while preventing higher molecular weight species from so doing. The low molecular weight species include not only the ionic species of the food grade salt but also low molecular weight materials extracted from the source material, such as carbohydrates, pigments, low molecular weight proteins and anti-nutritional factors, such as trypsin inhibitors, which are themselves low molecular weight proteins. The molecular weight cut-off of the membrane is usually chosen to ensure retention of a significant proportion of the protein in the solution, while permitting contaminants to pass through having regard to the different membrane materials and configurations.

The concentrated soy protein solution then may be subjected to a diafiltration step using water or a dilute saline solution. The diafiltration solution may be at its natural pH or at a pH equal to that of the protein solution being diafiltered or at any pH value in between. Such diafiltration may be effected using from about 2 to about 40 volumes of diafiltration solution, preferably about 5 to about 25 volumes of diafiltration solution. In the diafiltration operation, further quantities of contaminants are removed from the clear aqueous soy protein solution by passage through the membrane with the permeate. This purifies the clear aqueous protein solution and may also reduce its viscosity. The diafiltration operation may be effected until no significant further quantities of contaminants or visible colour are present in the permeate or until the retentate has been sufficiently purified so as, when dried, to provide a soy protein isolate with a protein content of at least about 90 wt % (N×6.25) d.b. Such diafiltration may be effected using the same membrane as for the concentration step. However, if desired, the diafiltration step may be effected using a separate membrane with a different molecular weight cut-off, such as a membrane having a molecular weight cut-off in the range of about 3,000 to about 1,000,000 Daltons, preferably about 5,000 to about 100,000 Daltons, having regard to different membrane materials and configuration.

Alternatively, the diafiltration step may be applied to the clear acidified aqueous protein solution prior to concentration or to the partially concentrated clear acidified aqueous protein solution. Diafiltration may also be applied at multiple points during the concentration process. When diafiltration is applied prior to concentration or to the partially concentrated solution, the resulting diafiltered solution may then be additionally concentrated. The viscosity reduction achieved by diafiltering multiple times as the protein solution is concentrated may allow a higher final, fully concentrated protein concentration to be achieved. This reduces the volume of material to be dried.

The concentration step and the diafiltration step may be effected herein in such a manner that the soy protein product subsequently recovered contains less than about 90 wt % protein (N×6.25) d.b., such as at least about 60 wt % protein (N×6.25) d.b. By partially concentrating and/or partially diafiltering the clear aqueous soy protein solution, it is possible to only partially remove contaminants. This protein solution may then be dried to provide a soy protein product with lower levels of purity. The soy protein product is still able to produce clear protein solutions under acidic conditions.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit the oxidation of any phenolics present in the concentrated soy protein solution.

The concentration step and the optional diafiltration step may be effected at any convenient temperature, generally about 2° to about 60° C., preferably about 20° to about 35° C., and for the period of time to effect the desired degree of concentration and diafiltration. The temperature and other conditions used to some degree depend upon the membrane equipment used to effect the membrane processing, the desired protein concentration of the solution and the efficiency of the removal of contaminants to the permeate.

There are two main trypsin inhibitors in soy, namely the Kunitz inhibitor, which is a heat-labile molecule with a molecular weight of approximately 21,000 Daltons, and the Bowman-Birk inhibitor, a more heat-stable molecule with a molecular weight of about 8,000 Daltons. The level of trypsin inhibitor activity in the final soy protein product can be controlled by manipulation of various process variables.

As noted above, heat treatment of the clear acidified aqueous soy protein solution may be used to inactivate heat-labile trypsin inhibitors. The partially concentrated or fully concentrated acidified soy protein solution may also be heat treated to inactivate heat labile trypsin inhibitors. When the heat treatment is applied to the partially concentrated acidified soy protein solution, the resulting heat treated solution may then be additionally concentrated.

In addition, the concentration and/or diafiltration steps may be operated in a manner favorable for removal of trypsin inhibitors in the permeate along with the other contaminants. Removal of the trypsin inhibitors is promoted by using a membrane of larger pore size, such as about 30,000 to about 1,000,000 Da, operating the membrane at elevated temperatures, such as about 30° to about 60° C. and employing greater volumes of diafiltration medium, such as about 20 to about 40 volumes.

Acidifying and membrane processing the diluted protein solution at a lower pH of about 1.5 to about 3 may reduce the trypsin inhibitor activity relative to processing the solution at higher pH of about 3 to about 4.4. When the protein solution is concentrated and diafiltered at the low end of the pH range, it may be desired to raise the pH of the retentate prior to drying. The pH of the concentrated and diafiltered protein solution may be raised to the desired value, for example pH 3, by the addition of any convenient food grade alkali, such as sodium hydroxide.

Further, a reduction in trypsin inhibitor activity may be achieved by exposing soy materials to reducing agents that disrupt or rearrange the disulfide bonds of the inhibitors. Suitable reducing agents include sodium sulfite, cysteine and N-acetylcysteine.

The addition of such reducing agents may be effected at various stages of the overall process. The reducing agent may be added with the soy protein source material in the extraction step, may be added to the clarified aqueous soy protein solution following removal of residual soy protein source material, may be added to the concentrated protein solution before or after diafiltration or may be dry blended with the dried soy protein product. The addition of the reducing agent may be combined with a heat treatment step and the membrane processing steps, as described above.

If it is desired to retain active trypsin inhibitors in the concentrated protein solution, this can be achieved by eliminating or reducing the intensity of the heat treatment step, not utilizing reducing agents, operating the concentration and diafiltration steps at the higher end of the pH range, such as about 3 to about 4.4, utilizing a concentration and diafiltration membrane with a smaller pore size, operating the membrane at lower temperatures and employing fewer volumes of diafiltration medium.

The concentrated and optionally diafiltered protein solution may be subject to a further defatting operation, if required, as described in U.S. Pat. Nos. 5,844,086 and 6,005,076. Alternatively, defatting of the concentrated and optionally diafiltered protein solution may be achieved by any other convenient procedure.

The concentrated and optionally diafiltered clear aqueous protein solution may be treated with an adsorbent, such as powdered activated carbon or granulated activated carbon, to remove colour and/or odour compounds. Such adsorbent treatment may be carried out under any convenient conditions, generally at the ambient temperature of the concentrated protein solution. For powdered activated carbon, an amount of about 0.025% to about 5% w/v, preferably about 0.05% to about 2% w/v, is employed. The adsorbent may be removed from the soy protein solution by any convenient means, such as by filtration.

The concentrated and optionally diafiltered clear aqueous soy protein solution may be dried by any convenient technique, such as spray drying or freeze drying. A pasteurization step may be effected on the soy protein solution prior to drying. Such pasteurization may be effected under any desired pasteurization conditions. Generally, the concentrated and optionally diafiltered soy protein solution is heated to a temperature of about 55° to about 70° C., preferably about 60° to about 65° C., for about 30 seconds to about 60 minutes, preferably about 10 minutes to about 15 minutes. The pasteurized concentrated soy protein solution then may be cooled for drying, preferably to a temperature of about 25° to about 40° C.

The dry soy protein product has a protein content in excess of about 60 wt % (N×6.25) d.b. Preferably, the dry soy protein product is an isolate with a high protein content, in excess of about 90 wt %, preferably at least about 100 wt %, (N×6.25) d.b.

As mentioned above, in attempting to use this soy protein isolate for protein fortification of a variety of commercial orange juice products, separation of components and the development of a substantially clear upper liquid layer in the orange juice was observed. According to the invention herein, calcium salts, organic acids or the two species in combination may be used to enable the soy protein isolate to be used to provide protein fortified citrus fruit juices without rapid development of the clear or nearly clear upper liquid layer in the fruit juice, particularly orange juice. Higher calcium levels are required to achieve stability when little or no organic acid is employed, while lower calcium values may be used where higher organic acid values are employed.

### EXAMPLES

### Example 1

This Example illustrates the production of the novel, acid soluble soy protein isolate.

‘a’ kg of defatted, minimally heat processed soy flour was added to ‘b’ L of 0.15 M CaCl₂ solution at ambient temperature and agitated for 60 minutes to provide an aqueous protein solution. The residual soy meal was removed and the resulting protein solution was clarified by centrifugation and filtration to produce ‘c’ L of filtered protein solution having a protein content of ‘d’ % by weight.

The filtered protein solution was then added to ‘e’ volume(s) of reverse osmosis purified water and the pH of the sample lowered to ‘f’ with diluted HCl.

The diluted and acidified protein extract solution was reduced in volume from ‘g’ L to ‘h’ L, by concentration on a ‘i’ membrane having a molecular weight cutoff of ‘j’ Daltons. The concentrated, acidified protein solution was diafiltered with ‘k’ L of reverse osmosis purified water. The resulting acidified, diafiltered, concentrated protein solution had a protein content of ‘l’ % by weight and represented a yield of ‘m’ wt % of the initial filtered protein solution. ‘n’ kg of the acidified, diafiltered, concentrated protein solution was passed through ‘o’ L bed volumes of granular activated carbon at a flowrate of ‘p’ bed volumes per hour and then dried to yield a product found to have a protein content of ‘q’ % (N×6.25) d.b. The product was given designation ‘r’ S701C.

The parameters ‘a’ to ‘r’ for three runs are set forth in the following Table 1. The S701C from the three runs was dry blended in the proportion 46.6 wt % S005-K18-08A S701C: 40.7 wt % S005-K24-08A S701C: 12.7 wt % S005-L08-08A S701C to form a product termed S701C Blend I.

TABLE 1
Parameters for the runs to produce S701C for S701C Blend I

| r | S005-K18-08A | S005-K24-08A | S005-L08-08A |
|---|---|---|---|
| a | 60 | 60 | 20 |
| b | 600 | 600 | 200 |
| c | 410 | 360 | 170 |
| d | 2.63 | 2.53 | 2.03 |
| e | 1 | 1 | 1 |
| f | 3.07 | 3.07 | 3.06 |
| g | 820 | 720 | 340 |
| h | 70 | 81 | 49 |
| i | PES | PES | PES |
| j | 10,000 | 10,000 | 10,000 |
| k | 350 | 405 | 250 |
| l | 13.34 | 13.52 | N/A |
| m | 89.6 | 91.1 | N/A |
| n | 36.21 | 30.68 | 17.82 |
| o | 5 | 3 | 1.5 |
| p | 2.5 | 2.5 | 2.5 |
| q | 103.76 | 104.03 | 104.84 |

N/A = not available

### Example 2

This Example illustrates the production of another batch of the novel, acid soluble soy protein isolate.

98.34 kg of defatted, minimally heat processed soy flour was added to 1,000 L of 0.15 M CaCl₂ solution at ambient temperature and agitated for 30 minutes to provide an aqueous protein solution. The residual soy flour was removed and the resulting protein solution was clarified by centrifugation and filtration to produce 670.1 L of filtered protein solution having a protein content of 2.38% by weight.

The filtered protein solution was then added to 1 volume of reverse osmosis purified water and the pH of the sample lowered to 3.14 with diluted HCl.

The diluted and acidified protein extract solution was reduced in volume from 1,350 L to 100 L by concentration on a polyethersulfone (PES) membrane having a molecular weight cutoff of 100,000 Daltons. The concentrated, acidified protein solution was diafiltered with 1,000 L of reverse osmosis purified water. The resulting acidified, diafiltered, concentrated protein solution had a protein content of 8.95% by weight and represented a yield of 74.6 wt % of the initial filtered protein solution. The acidified, diafiltered, concentrated protein solution was then dried to yield a product found to have a protein content of 101.31% (N×6.25) d.b. The product was given designation S008-C02-09A 5701.

### Example 3

This Example illustrates the effect of addition of the novel soy protein isolate to commercial orange juice products.

Sufficient soy protein isolate powder (S701C) from batch S005-K24-08A, prepared as described in Example 1, was added to commercial orange juice products to provide a protein concentration of 2% w/v and solubilized with a magnetic stirrer. The protein fortified products were stored at 4° C. for 24 hours and visually observed after 1 and 24 hours. Commercial orange juice products tested were Tropicana Essentials Low Acid Orange juice, Tropicana Essentials Calcium Orange Juice, Tropicana Essentials Omega-3 Orange Juice, Tropicana Premium No Pulp Orange Juice and Tropicana Premium Orange Juice with Pulp.

After one hour storage at 4° C., some settling of solids was observed in all orange juice samples except for the Tropicana Essentials Calcium Orange Juice product, which appeared to be homogeneous without any separation. After 24 hours storage at 4° C., all samples had separated with the development of a clear or nearly clear upper liquid layer (termed herein separation with clarification).

### Example 4

This Example illustrates attempts to stabilize an orange juice product having the novel soy protein isolate therein using malic acid.

Soy protein powder, prepared as described in Example 2, malic acid and Sun-Rype Orange Juice (aseptically processed) were weighed into glass vials according to the formulations shown in Table 2.

TABLE 2
Formulations for trials with malic acid

Sample number

| | 1 | 2 |
|---|---|---|
| wt orange juice (g) | 30.65 | 30.65 |
| wt protein powder (g) | 0.63 | 0.63 |
| wt malic acid (g) | 0.15 | 0.30 |
| % protein (w/w) | 1.91 | 1.90 |
| % malic acid (w/w) | 0.48 | 0.95 |

The vials were mixed with a vortex mixer operated at mid-speed until the added compounds were completely dissolved. A control orange juice sample was poured in a glass vial without malic acid and without soy protein. Samples were placed in storage at 4° C. and visually observed after 24 hours. After the 24 hour storage at 4° C., the 0.48% w/w malic acid sample had separation with clarification. After the same length of storage time, the sample containing 0.95% w/w malic acid did not exhibit separation with clarification.

It appeared that malic acid alone was able to stabilize Sun-Rype Orange Juice containing approximately 1.9% w/w of the novel soy protein when employed at a level of 0.95% w/w.

### Example 5

This Example illustrates attempts to stabilize an orange juice product having the novel soy protein isolate therein using calcium lactate.

Soy protein powder, prepared as described in Example 1, calcium lactate and Sun-Rype Orange Juice (aseptically processed) were weighed into glass vials according to the formulations shown in Table 3.

TABLE 3
Formulations for trials with calcium lactate

Sample number

| | 1 | 2 | 3 | 4 |
|---|---|---|---|---|
| wt orange juice (g) | 30.65 | 30.65 | 30.65 | 30.65 |
| wt protein powder (g) | 0.62 | 0.62 | 0.62 | 0.62 |
| wt calcium lactate (g) | 0.024 | 0.12 | 0.24 | 0.33 |
| % protein (w/w) | 1.91 | 1.91 | 1.90 | 1.89 |
| % calcium lactate (w/w) | 0.08 | 0.38 | 0.76 | 1.04 |

The vials were mixed with a vortex mixer operated at mid-speed until the added compounds were completely dissolved. A control orange juice sample was poured in a glass vial without soy protein and calcium lactate. Samples were placed in storage at 4° C. and visually observed after 24 hours.

The results obtained are set forth in the following Table 4:

TABLE 4
Observations of Sun-Rype Orange Juice containing soy protein and
calcium lactate

| % calcium lactate (w/w) | Observation |
|---|---|
| 0.08 | Separation with clarification |
| 0.38 | Separation with clarification |
| 0.76 | Separation with clarification |
| 1.04 | Same appearance as control orange |
| | juice sample |

As may be seen from the results presented in Table 4, orange juice samples containing approximately 1.9% w/w protein and 0.08%, 0.38% and 0.76% w/w of calcium lactate were not stable and showed separation with clarification. The sample containing 1.04% w/w calcium lactate, however, did not have separation with clarification and had an appearance similar to the control sample.

### Example 6

This Example illustrates attempts to stabilize an orange juice product having the novel soy protein isolate therein using calcium lactate and malic acid.

Soy protein powder, prepared as described in Example 1, calcium lactate, malic acid and Sun-Rype Orange Juice (aseptically processed) were weighed into glass vials according to the formulations shown in Table 5.

TABLE 5
Formulations for trials with calcium lactate and malic acid

Sample number

| | 1 | 2 | 3 | 4 |
|---|---|---|---|---|
| wt orange juice (g) | 30.65 | 30.65 | 30.65 | 30.65 |
| wt protein powder (g) | 0.62 | 0.62 | 0.62 | 0.62 |
| wt calcium lactate (g) | 0.024 | 0.024 | 0.24 | 0.24 |
| wt malic acid (g) | 0.03 | 0.30 | 0.03 | 0.30 |
| % protein (w/w) | 1.91 | 1.89 | 1.90 | 1.88 |
| % calcium lactate (w/w) | 0.08 | 0.08 | 0.76 | 0.75 |
| % malic acid (w/w) | 0.10 | 0.95 | 0.10 | 0.94 |

The vials were mixed with a vortex mixer operated at mid-speed until the added compounds were completely dissolved. A control orange juice sample was poured in a glass vial without soy protein, calcium lactate or malic acid. Samples were stored at 4° C. and visually observed after 24 hours.

The results obtained are set forth in the following Table 6:

TABLE 6
Observations of Sun-Rype Orange Juice containing soy protein, calcium
lactate and malic acid

| % calcium lactate | % malic acid | |
|---|---|---|
| (w/w) | (w/w) | Observation |
| 0.08 | 0.10 | Separation with clarification |
| 0.08 | 0.95 | Same appearance as control orange |
| | | juice sample |
| 0.76 | 0.10 | Separation with clarification |
| 0.75 | 0.94 | Same appearance as control orange |
| | | juice sample |

As may be seen from the results in Table 6, samples containing 0.1% w/w malic acid exhibited separation with clarification, while samples with the higher levels of malic acid did not have separation with clarification and appeared similar to the control sample.

### Example 7

This Example illustrates attempts to stabilize an orange juice product having the novel soy protein isolate therein using calcium chloride.

The procedure of Example 5 was repeated with calcium chloride substituting for calcium lactate. The formulations utilized are shown below in Table 7.

TABLE 7
Formulations for trials with calcium chloride

Sample number

| | 1 | 2 | 3 | 4 |
|---|---|---|---|---|
| wt orange juice (g) | 30.65 | 30.65 | 30.65 | 30.65 |
| wt protein powder (g) | 0.62 | 0.62 | 0.62 | 0.62 |
| wt calcium chloride (g) | 0.012 | 0.03 | 0.06 | 0.12 |
| % protein (w/w) | 1.91 | 1.91 | 1.91 | 1.91 |
| % calcium chloride (w/w) | 0.04 | 0.10 | 0.19 | 0.38 |

The results obtained are set forth in the following Table 8:

TABLE 8
Observations of Sun-Rype Orange Juice containing
soy protein and calcium chloride

| % calcium chloride (w/w) | Observation |
|---|---|
| 0.04 | Separation with clarification |
| 0.10 | Separation with clarification |
| 0.19 | Separation with clarification |
| 0.38 | Same appearance as control |
| | orange juice sample |

As can be seen from the results provided in Table 8, samples containing 0.04%, 0.10% and 0.19% w/w calcium chloride were unstable and exhibited separation with clarification. However, the sample with 0.38% w/w calcium chloride did not have separation with clarification and looked similar to the control sample.

### Example 8

This Example illustrates attempts to stabilize an orange juice product having the novel soy protein isolate therein using calcium chloride and malic acid.

The procedure of Example 6 was repeated substituting calcium chloride for calcium lactate. The formulations utilized are shown below in Table 9.

TABLE 9
Formulations for trials with calcium chloride and malic acid

| | Sample number | | | |
|---|---|---|---|---|
| | 1 | 2 | 3 | 4 |
| wt orange juice (g) | 30.65 | 30.65 | 30.65 | 30.65 |
| wt protein powder (g) | 0.62 | 0.62 | 0.62 | 0.62 |
| wt calcium chloride (g) | 0.012 | 0.012 | 0.06 | 0.06 |
| wt malic acid (g) | 0.03 | 0.30 | 0.03 | 0.30 |
| % protein (w/w) | 1.91 | 1.89 | 1.91 | 1.89 |
| % calcium chloride (w/w) | 0.04 | 0.04 | 0.19 | 0.19 |
| % malic acid (w/w) | 0.10 | 0.95 | 0.10 | 0.95 |

The results obtained are set forth in the following Table 10:

TABLE 10
Observations of Sun-Rype Orange Juice containing
soy protein, calcium chloride and malic acid

| % calcium chloride | % malic acid | |
|---|---|---|
| (w/w) | (w/w) | Observation |
| 0.04 | 0.10 | Separation with clarification |
| 0.04 | 0.95 | Same appearance as control |
| | | orange juice sample |
| 0.19 | 0.10 | Separation with clarification |
| 0.19 | 0.95 | Same appearance as control |
| | | orange juice sample |

As can be seen from the results presented in Table 10, samples containing 0.1% w/w malic acid exhibited separation with clarification while samples with 0.95% w/w malic acid appeared similar to the control sample.

### Example 9

This Example illustrates attempts to stabilize an orange juice product having the novel soy protein isolate therein using calcium lactate gluconate.

The procedure of Example 5 was repeated with calcium lactate gluconate (CLG) substituting for calcium lactate. The formulations utilized are shown below in Table 11.

TABLE 11
Formulations for trials with calcium lactate gluconate

| | Sample number | | | |
|---|---|---|---|---|
| | 1 | 2 | 3 | 4 |
| wt orange juice (g) | 35.75 | 35.75 | 35.75 | 35.75 |
| wt protein powder (g) | 0.73 | 0.73 | 0.73 | 0.73 |
| wt calcium lactate gluconate (g) | 0.035 | 0.175 | 0.350 | 0.455 |
| % protein (w/w) | 1.93 | 1.92 | 1.91 | 1.91 |
| % calcium lactate gluconate (w/w) | 0.10 | 0.48 | 0.95 | 1.23 |

The results obtained are set firth in the following Table 12:

TABLE 12
Observations of Sun-Rype Orange Juice containing
soy protein and calcium lactate gluconate

| % calcium lactate | |
|---|---|
| gluconate (w/w) | Observation |
| 0.10 | Separation with clarification |
| 0.48 | Separation with clarification |
| 0.95 | Same appearance as control |
| | orange juice sample |
| 1.23 | Same appearance as control |
| | orange juice sample |

As can be seen from the results presented in Table 12, orange juice samples containing 0.10% and 0.48% w/w calcium lactate gluconate were not stable and exhibited separation with clarification. Samples with 0.95% and 1.23% w/w calcium lactate gluconate did not have separation with clarification and appeared similar to the control sample

### Example 10

This Example illustrates attempts to stabilize an orange juice product having the novel soy protein isolate therein using calcium lactate gluconate and malic acid.

The procedure of Example 6 was repeated, substituting calcium lactate gluconate for calcium lactate. The formulations utilized are shown below in Table 13,

TABLE 13
Formulations for trials with calcium lactate gluconate and malic acid

| | Sample number | | | |
|---|---|---|---|---|
| | 1 | 2 | 3 | 4 |
| wt orange juice (g) | 30.65 | 30.65 | 30.65 | 30.65 |
| wt protein powder (g) | 0.62 | 0.62 | 0.62 | 0.62 |
| wt calcium lactate gluconate (g) | 0.03 | 0.03 | 0.15 | 0.15 |
| wt malic acid (g) | 0.03 | 0.30 | 0.03 | 0.30 |
| % protein (w/w) | 1.91 | 1.89 | 1.90 | 1.89 |
| % calcium lactate gluconate (w/w) | 0.10 | 0.09 | 0.48 | 0.47 |
| % malic acid (w/w) | 0.10 | 0.95 | 0.10 | 0.95 |

The results obtained are set forth in the following Table 14:

TABLE 14
Observations of Sun-Rype Orange Juice containing
soy protein, CLG and malic acid

| % calcium lactate | % malic acid | |
|---|---|---|
| gluconate (w/w) | (w/w) | Observation |
| 0.10 | 0.10 | Separation with clarification |
| 0.09 | 0.95 | Same appearance as control |
| | | orange juice sample |
| 0.48 | 0.10 | More settled solids than control |
| | | orange juice sample but not |
| | | separation with clarification |
| 0.47 | 0.95 | Same appearance as control |
| | | orange juice sample |

As can be seen from the results presented in Table 14, samples containing 0.95% w/w malic acid were more stable than the samples containing 0.10% w/w malic acid and appeared similar to the control sample. The sample with 0.48% w/w CLG and 0.1% w/w malic acid appeared to contain more settled solids than the control orange juice sample, but had an opaque upper layer, while separation with clarification was observed for the sample with 0.1% CLG w/w and 0.1% w/w malic acid.

### Example 11

This Example illustrates attempts to stabilize an orange juice product having the novel soy protein isolate therein using malic acid along with calcium lactate, calcium chloride or calcium lactate gluconate.

Soy protein powder, prepared as described in Example 1, calcium salts, malic acid and Sun-Rype Orange Juice (aseptically processed) were weighed into glass vials according to the formulations shown in Table 15.

TABLE 15
Formulations for trials with soy protein isolate from Example 1

| | Sample number | | |
|---|---|---|---|
| | 1 | 2 | 3 |
| wt orange juice (g) | 30.65 | 30.65 | 30.65 |
| wt protein powder (g) | 0.62 | 0.62 | 0.62 |
| wt calcium lactate (g) | 0.24 | 0.00 | 0.00 |
| wt calcium chloride (g) | 0.00 | 0.06 | 0.00 |
| wt calcium lactate gluconate (g) | 0.00 | 0.00 | 0.15 |
| wt malic acid (g) | 0.15 | 0.15 | 0.15 |
| % protein (w/w) | 1.89 | 1.90 | 1.89 |
| % calcium lactate (w/w) | 0.76 | 0.00 | 0.00 |
| % calcium chloride (w/w) | 0.00 | 0.19 | 0.00 |
| % calcium lactate gluconate (w/w) | 0.00 | 0.00 | 0.48 |
| % malic acid (w/w) | 0.47 | 0.48 | 0.48 |

Samples were also prepared with soy protein powder, prepared as described in Example 2, calcium salts, malic acid and Sun-Rype Orange Juice (aseptically processed) weighed into glass vials according to the formulations shown in Table 16.

TABLE 16
Formulations for trials with soy protein isolate from Example 2

| | Sample number | | |
|---|---|---|---|
| | 1 | 2 | 3 |
| wt orange juice (g) | 30.65 | 30.65 | 30.65 |
| wt protein powder (g) | 0.63 | 0.63 | 0.63 |
| wt calcium lactate (g) | 0.024 | 0.00 | 0.00 |
| wt calcium chloride (g) | 0.00 | 0.012 | 0.00 |
| wt calcium lactate gluconate (g) | 0.00 | 0.00 | 0.03 |
| wt malic acid (g) | 0.15 | 0.15 | 0.15 |
| % protein (w/w) | 1.91 | 1.91 | 1.91 |
| % calcium lactate (w/w) | 0.08 | 0.00 | 0.00 |
| % calcium chloride (w/w) | 0.00 | 0.04 | 0.00 |
| % calcium lactate gluconate (w/w) | 0.00 | 0.00 | 0.10 |
| % malic acid (w/w) | 0.48 | 0.48 | 0.48 |

Samples were mixed with a vortex mixer operated at medium speed until the added compounds were completely solubilized. Samples were placed and in storage at 4° C. and visually observed after 24 hours. A control sample was prepared with no soy protein, malic acid or calcium salt present.

The results obtained are set forth in the following Tables 17 to 19:

TABLE 17
Observations of Sun-Rype Orange Juice containing
soy protein, calcium lactate and malic acid

| % calcium | % malic | |
|---|---|---|
| lactate (w/w) | acid (w/w) | Observation |
| 0.08 | 0.48 | Separation with clarification |
| 0.76 | 0.47 | Same appearance as |
| | | control orange juice sample |

TABLE 18
Observations of Sun-Rype Orange Juice containing
soy protein, calcium chloride and malic acid

| % calcium | % malic | |
|---|---|---|
| chloride (w/w) | acid (w/w) | Observation |
| 0.04 | 0.48 | Separation with clarification |
| 0.19 | 0.48 | Same appearance as control |
| | | orange juice sample |

TABLE 19
Observations of Sun-Rype Orange Juice containing
soy protein, calcium lactate gluconate and malic acid

| % calcium lactate | % malic | |
|---|---|---|
| gluconate (w/w) | acid (w/w) | Observation |
| 0.10 | 0.48 | Separation with clarification |
| 0.48 | 0.48 | Same appearance as control |
| | | orange juice sample |

As can be seen from the results presented in Tables 17 to 19, the samples with lower levels of calcium showed separation with clarification whereas those with higher calcium levels did not have separation with clarification and appeared similar to the control sample.

### Example 12

This Example illustrates the heat stability of an orange juice product containing the novel soy protein isolate and various quantities of calcium salts and malic acid.

Soy protein powder, prepared as described in Example 2, calcium salts, malic, acid and Sun-Rype Orange Juice (aseptically processed) were weighed into beakers according to the formulations shown in Table 20.

TABLE 20
Formulations for heat treatment trial

| Sample number | 1 | 2 | 3 | 4 | 5 | 6 | 7 |
|---|---|---|---|---|---|---|---|
| wt orange juice (g) | 204.30 | 204.30 | 204.30 | 204.30 | 204.30 | 204.30 | 204.30 |
| wt protein powder (g) | 4.19 | 4.19 | 4.19 | 4.19 | 4.19 | 4.19 | 4.19 |
| wt calcium lactate (g) | 0.00 | 0.16 | 0.00 | 0.00 | 2.20 | 0.00 | 0.00 |
| wt calcium chloride (g) | 0.00 | 0.00 | 0.08 | 0.00 | 0.00 | 0.80 | 0.00 |
| wt CLG (g) | 0.00 | 0.00 | 0.00 | 0.20 | 0.00 | 0.00 | 2.00 |
| wt malic acid (g) | 0.00 | 2.00 | 2.00 | 2.00 | 0.00 | 0.00 | 0.00 |
| % protein (w/w) | 1.92 | 1.90 | 1.90 | 1.90 | 1.90 | 1.91 | 1.90 |
| % calcium lactate (w/w) | 0.00 | 0.08 | 0.00 | 0.00 | 1.04 | 0.00 | 0.00 |
| % calcium chloride (w/w) | 0.00 | 0.00 | 0.04 | 0.00 | 0.00 | 0.38 | 0.00 |
| % CLG (w/w) | 0.00 | 0.00 | 0.00 | 0.09 | 0.00 | 0.00 | 0.95 |
| % malic acid (w/w) | 0.00 | 0.95 | 0.95 | 0.95 | 0.00 | 0.00 | 0.00 |

The mixtures were stirred with a magnetic stirrer for one hour. The resulting samples were heat-treated at 85° C. for 30 seconds and then chilled in an ice-bath. The samples were transferred to food-grade plastic bottles, placed in storage at 4° C. and visually observed after 24 hours.

The results obtained are set forth in the following Table 21:

TABLE 21
Observations of heat-treated Sun-Rype Orange Juice containing
soy protein and calcium salts with or without malic acid

| Added calcium | % malic acid | |
|---|---|---|
| concentration (% w/w) | (w/w) | Observation |
| 0.00 | 0.00 | Separation with clarification |
| 0.08% calcium lactate | 0.95 | No separation with clarification |
| 1.04% calcium lactate | 0.00 | No separation with clarification |
| 0.04% calcium chloride | 0.95 | No separation with clarification |
| 0.38% calcium chloride | 0.00 | No separation with clarification |
| 0.09% CLG | 0.95 | No separation with clarification |
| 0.95% CLG | 0.00 | No separation with clarification |

As can be seen from the results provided in Table 21, the sample containing soy protein with no malic acid or calcium salt showed separation with clarification. The remaining samples did not have separation with clarification.

It can be concluded from this data that the stability of Sun-Rype orange juice containing the novel soy protein isolate stabilized with malic acid and calcium salt was not adversely affected by the heat treatment at 85° C.

### Example 13

This Example illustrates attempts to stabilize an orange juice product having the novel soy protein isolate therein using calcium lactate and citric acid.

Soy protein powder, prepared as described in Example 1, calcium lactate, citric acid and Sun-Rype Orange Juice (aseptically processed) were weighed into glass vials according to the formulations shown in Table 22.

TABLE 22
Formulations for trials with calcium lactate and citric acid

Sample number

| | 1 | 2 |
|---|---|---|
| wt orange juice (g) | 20.43 | 20.43 |
| wt protein powder (g) | 0.41 | 0.41 |
| wt calcium lactate (g) | 0.016 | 0.016 |
| wt citric acid (g) | 0.00 | 0.2 |
| % protein (w/w) | 1.90 | 1.88 |
| % calcium lactate (w/w) | 0.08 | 0.08 |
| % citric acid (w/w) | 0.00 | 0.95 |

The vials were mixed with a vortex mixer operated at mid-speed until the added compounds were completely dissolved. A control orange juice sample was poured in a glass vial without soy protein, calcium lactate or citric acid. Samples were stored at 4° C. and visually observed after 24 hours.

The results obtained are set forth in the following Table 23:

TABLE 23
Observations of Sun-Rype Orange Juice containing
soy protein, calcium lactate and citric acid

| % calcium lactate | % citric | |
|---|---|---|
| (w/w) | acid (w/w) | Observation |
| 0.08 | 0.00 | Separation with clarification |
| 0.08 | 0.95 | Same appearance as control |
| | | orange juice sample |

As may be seen from the results provided in Table 23, the sample containing soy protein and 0.08% w/w calcium lactate alone exhibited separation with clarification, while the sample with the same level of calcium lactate plus 0.95% w/w citric acid did not have separation with clarification and appeared similar to the control sample.

### SUMMARY OF THE DISCLOSURE

In summary of this disclosure, unstable soy protein isolate fortified citrus fruit solutions can be stabilized against the separation of citrus fruit components and the rapid development of a clear or nearly clear upper liquid layer by the utilization of calcium salts, organic acids or the two species in combination. Modifications are possible within the scope of this invention.

What we claim is:

1. A composition comprising:
a soy protein product having a protein content of at least about 60 wt % (N×6.25) which is completely soluble in water at an acid pH value of less than about 4.4 and which is heat stable in aqueous solution, and at least one of
at least one calcium salt and
at least one organic acid,
said composition being soluble in citrus fruit juices or beverages containing citrus fruit juices without separation of components of the citrus fruit juice or beverage and the rapid development of a substantially clear upper liquid layer in the juice or beverage.

2. The composition of claim 1 wherein said at least one calcium salt is selected from the group consisting of calcium chloride, calcium lactate and calcium lactate gluconate.

3. The composition of claim 1 wherein the at least one organic acid is malic acid or citric acid.

4. The composition of claim 1 wherein the citrus fruit juice is orange juice.

5. The composition of claim 1 wherein the soy protein product has a protein content of at least about 90 wt % (N×6.25) d.b.

6. The composition of claim 5 wherein the soy protein product has a protein content of at least about 100 wt % (N×6.25) d.b.

7. A protein-fortified citrus fruit juice or beverage containing citrus fruit juice having dissolved therein the composition of claim 1.

8. The citrus fruit juice or beverage containing citrus fruit juice of claim 7 which is protein-fortified orange juice.

9. The citrus fruit juice or beverage containing citrus fruit juice of claim 5, the composition of which comprises:
about 0.1 to about 10% w/w of soy protein from soy protein product, and at least
one of about 0 to about 1.7% w/w of at least one calcium salt, and
about 0 to about 1% w/w of at least one organic acid.

10. The citrus fruit juice or beverage containing citrus fruit juice of claim 9 wherein said at least one calcium salt is selected from the group consisting of calcium chloride, calcium lactate and calcium lactate gluconate and said at least one organic acid is one of malic acid and citric acid.
